(19) United States
(12) Patent Application Publication
(10) Pub. No.: US 2026/0166965 A1
(43) Pub. Date: Jun. 18, 2026

(54) HEAT PUMP SYSTEM FOR VEHICLE

(71) Applicants: Hyundai Motor Company, Seoul (KR); Kia Corporation, Seoul (KR)

(72) Inventors: Jong Il Park, Hwaseong-si (KR); Yeon Ho Kim, Hwaseong-si (KR); Yeongjae Park, Hwaseong-si (KR)

(21) Appl. No.: 19/252,439

(22) Filed: Jun. 27, 2025

(30) Foreign Application Priority Data
Dec. 13, 2024 (KR) 10-2024-0185994

(51) Int. Cl. B60H 1/32

(52) U.S. Cl. CPC B60H 1/32284

(57) ABSTRACT

A heat pump system for a vehicle may be capable of streamlining the entire system and reducing the manufacturing cost and weight by controlling the flowing movement of the coolant flowing in respective cooling apparatuses by using a single control valve depending on at least one mode for adjusting the temperature of the vehicle interior and for adjusting the temperature of the battery, such as in an extended range electric vehicle (EREV) applied with an engine for charging a battery, and may be capable of adjusting the temperature of the vehicle interior and also efficiently controlling the battery temperature, by using the thermal energy generated from the engine.

### CROSS-REFERENCE TO RELATED APPLICATIONS

This application claims priority to and the benefit of Korean Patent Application No. 10-2024-0185994 filed with the Korean Intellectual Property Office on December 13, 2024, the entire contents of which is incorporated herein by reference.

### TECHNICAL FIELD

The present disclosure relates to a heat pump system for a vehicle.

### BACKGROUND

In general, improving fuel efficiency of vehicles is a key technology that will determine the survival of the future automobile industry. Accordingly, major automobile manufacturers are putting all their efforts into researching for improving the fuel efficiency of their vehicles to meet the demands of the times, such as environmental and fuel efficiency regulations.

Recently, in accordance with a continuous increase in interest in energy efficiency and an environmental pollution problem, the development of an environment-friendly vehicle capable of substantially substituting for an internal combustion engine vehicle is studied, and the environment-friendly vehicle can be classified into an electric vehicle driven using a fuel cell or electricity as a power source and a hybrid vehicle driven using an engine and a battery.

An electric vehicle (hereinafter referred to as “EV”) includes at least one high-voltage battery configured to supply power and enable movement.

Such a battery discharges over time or when used, and requires charging. Accordingly, a typical EV may charge the battery by physically connecting to an external power supply by using a charging cable.

Recently, extended range electric vehicles (EREVs) that use a motor for driving and an engine only for charging to extend the driving distance are on the rise.

The EREV can be an electric vehicle that uses the power of an internal combustion engine to charge a high-voltage battery, but does not transmit the power of the engine to the wheels.

Accordingly, in the EREV, the engine can charge the battery using a motor generator unit (MGU) operated by the power of the engine when the state of charge (SOC) of the battery is low.

Such an EREV may include, not only a cooling apparatus for the engine and the electrical component for adjusting the temperature of the engine and the electrical component by circulating the coolant, but also a heat pump system for adjusting the vehicle interior temperature by circulating the refrigerant.

However, in such a conventional EREV, an engine cooling apparatus, an electrical component cooling apparatus, a battery cooling apparatus, and an air conditioner unit may be configured as separate closed circuits, respectively.

Accordingly, the EREV may have the disadvantage of increasing the size and weight of the cooling module disposed at the front of the vehicle, and complicating the layout of the connecting pipes that supply the refrigerant or the coolant to respective devices in the narrow front space of the vehicle.

In addition, each device and heat pump system must be equipped with a plurality of valves to control the flow of the coolant and the refrigerant by connecting respective connecting pipes, which makes it difficult to control respective valves and increases the manufacturing cost and weight.

In addition, there is a disadvantage in that noise and vibration caused by frequent opening and closing of each valve are transmitted to the vehicle interior, which reduces ride comfort.

Accordingly, there is a need for technology development to control the temperature of the battery together with the temperature of the vehicle interior by utilizing the thermal energy generated when the engine is in operation, while reducing the number of valves applied to each cooling device applied to EREV.

The above information disclosed in this Background section is only for enhancement of understanding of the background of the present disclosure, and therefore it may contain information that does not form the prior art that is already publicly known, available, or in use.

### SUMMARY

The present disclosure relates to a heat pump system for a vehicle, and more particularly, the present disclosure relates to a heat pump system for a vehicle that can heat the vehicle interior by using a high-temperature coolant, and that is applicable to an extended range electric vehicle (EREV) provided with an engine to charge a battery for supplying electrical power the motor.

An embodiment of the present disclosure can provide a heat pump system for a vehicle capable of streamlining the entire system and reducing the manufacturing cost and weight by controlling the flowing movement of the coolant flowing in respective cooling apparatuses by using a single valve depending on at least one mode for adjusting the temperature of the vehicle interior and for adjusting the temperature of the battery, in an extended range electric vehicle (EREV) applied with an engine for charging a battery.

An embodiment of the present disclosure can provide a heat pump system for a vehicle, capable of adjusting the temperature of the vehicle interior and also efficiently controlling the battery temperature, by using the thermal energy generated from the engine.

A heat pump system for a vehicle may include: a first cooling apparatus including a first line through which a coolant flows, and a first radiator, an engine, and a first water pump provided on the first line; a second cooling apparatus including a second line through which the coolant flows, and a second radiator, an electrical component, and a second water pump provided on the second line; a third cooling apparatus including a third line through which the coolant flows, and a battery and a third water pump provided on the third line; a control valve selectively connected to the first cooling apparatus and the third cooling apparatus, and configured to control a flowing movement of the interiorly introduced coolant depending on at least one mode for adjusting a temperature of a vehicle interior or for adjusting a temperature of a battery; a fourth line having a first end and a second end respectively connected the control valve to selectively allow the coolant to flow; a heater core provided on the fourth line; an air conditioner unit including a first refrigerant line through which a refrigerant flows; and a compressor, a heat-exchanger, a first expansion valve, and an evaporator provided on the first refrigerant line, where the first cooling apparatus may further include a first connection line having a first end connected to the control valve, and a second end connected to the first line between the first radiator and the first water pump, and a second connection line having a first end connected to the control valve, and a second end connected to an integrated flow control valve provided in the engine.

The air conditioner unit may further include: a first refrigerant valve provided on the first refrigerant line between the compressor and the heat-exchanger; a second refrigerant line having a first end connected to the first refrigerant valve; a refrigerant connection line having a first end connected to the first refrigerant line between the heat-exchanger and the first expansion valve, and a second end connected to the first refrigerant line between the evaporator and the compressor; a chiller provided on the refrigerant connection line so as to adjust a temperature of the coolant by heat-exchanging the selectively introduced coolant and the refrigerant, and connected to the third line; a second expansion valve provided on the refrigerant connection line between a first end of the refrigerant connection line and the chiller; and a second refrigerant valve provided on the refrigerant connection line between a second end of the refrigerant connection line and the chiller, and connected to a second end of the second refrigerant line.

The air conditioner unit may further include: a third refrigerant line having a first end connected to the first refrigerant line between the compressor and the heat-exchanger, and a second end connected to the first refrigerant line between the evaporator and the compressor; and a third refrigerant valve provided on the third refrigerant line.

The at least one mode may include: a first mode for heating the battery by using the thermal energy generated from the engine; a second mode for heating the vehicle interior by using the thermal energy generated from the engine; a third mode for cooling the battery by using the coolant cooled in the first radiator; a fourth mode for cooling the vehicle interior by using the air conditioner unit, and for cool the battery by using the coolant cooled while heat-exchanging with the refrigerant in the chiller; and a fifth mode for heating the vehicle interior by using the coolant heated while heat-exchanging with the refrigerant at the chiller, and for heating the battery.

In the first mode, a portion of the first line connecting the integrated flow control valve to the first radiator and a second end of the first connection line may be closed by the integrated flow control valve, a remaining first line connecting the second end of the first connection line to the first water pump and the engine may be opened by the integrated flow control valve, the first connection line and the second connection line may be opened by the control valve, the third line may be opened by the control valve, the fourth line may be closed by the control valve, the first water pump and the third water pump may be operated, and an operation of the air conditioner unit may be stopped.

In the second mode, a portion of the first line connecting the integrated flow control valve to the first radiator and a second end of the first connection line may be closed by the integrated flow control valve, a remaining first line connecting the second end of the first connection line to the first water pump and the engine may be opened by the integrated flow control valve, the first connection line and the second connection line may be opened by the control valve, the third line may be closed by the control valve, the fourth line may be opened by the control valve, the first water pump may be operated, and an operation of the air conditioner unit may be stopped.

In the third mode, a portion of the first line connecting the integrated flow control valve to the first radiator and a second end of the first connection line may be opened by the integrated flow control valve, a remaining first line connecting the second end of the first connection line to the first water pump and the engine may be closed by the integrated flow control valve, the first connection line and the second connection line may be opened by the control valve, the third line may be opened by the control valve, the fourth line may be closed by the control valve, the third water pump may be operated, and an operation of the air conditioner unit may be stopped.

In the fourth mode, the first connection line and the second connection line may be closed by the control valve, the third line may be opened by the control valve, the fourth line may be closed by the control valve, the third water pump may be operated, the first refrigerant line may be opened by the first expansion valve and the first refrigerant valve, the second refrigerant line may be closed by the first refrigerant valve and the second refrigerant valve, the third refrigerant line may be closed by the third refrigerant valve, the refrigerant connection line may be opened by the second expansion valve, the first expansion valve may expand the refrigerant introduced through the first refrigerant line from the heat-exchanger and may supply the expanded refrigerant to the evaporator, the second expansion valve may expand the refrigerant introduced through the refrigerant connection line and may supply the expanded refrigerant to the chiller, and the refrigerant having passed through the chiller may be introduced into the compressor together with the refrigerant discharged from the evaporator.

In the fifth mode, the first connection line and the second connection line may be closed by the control valve, the third line may be opened by the control valve, the fourth line may be opened by the control valve, the third water pump may be operated, a portion of the first refrigerant line connecting the first refrigerant valve to a first end of the third refrigerant line may be closed by the first refrigerant valve, a portion of the first refrigerant line connecting a first end of the refrigerant connection line to a second end of the third refrigerant line by passing through the evaporator may be closed by the first expansion valve, the second refrigerant line may be opened by the first refrigerant valve and the second refrigerant valve, a portion of the refrigerant connection line connecting the first end of the refrigerant connection line to the second refrigerant valve may be opened by the second expansion valve and the second refrigerant valve, a remaining refrigerant connection line connecting the second end of the refrigerant connection line to the second refrigerant valve may be closed by the second refrigerant valve, the third refrigerant line may be opened by the third refrigerant valve, the first expansion valve may stop operating, and the second expansion valve may expand the refrigerant introduced through the refrigerant connection line from the chiller and may supply the expanded refrigerant to the heat-exchanger.

The heat-exchanger and the chiller may be configured to selectively condense or evaporate the refrigerant introduced in the at least one mode.

The second expansion valve may be an electronic expansion valve configured to selectively expand the refrigerant while controlling a flowing movement of the supplied refrigerant.

The first refrigerant valve and the second refrigerant valve may be 3-way valves capable of controlling the flow rate of the refrigerant distribution and flowing movement.

When cooling of the electrical component is required in the at least one mode, the second cooling apparatus may be selectively operated so that the coolant flows along the second line.

The air conditioner unit may further include a heating, ventilation, and air conditioning (HVAC) module internally provided with the heater core and the evaporator, and including an opening/closing door configured to adjust the air having passed through the evaporator to be selectively introduced into the heater core depending on cooling or heating of the vehicle interior.

The third cooling apparatus may further include an air separator provided on the third line between the control valve and a battery module.

The second cooling apparatus may further include a reservoir tank provided on the second line.

The air separator may be configured to separate bubbles generated from the coolant flowing in the third cooling apparatus and discharge the separated bubbles to the reservoir tank, and connected to the reservoir tank through a coolant connection line so that the coolant of the second cooling apparatus and the third cooling apparatus communicate with each other.

The third cooling apparatus may further include a coolant heater provided on the third line at an upstream end of the battery.

As described above, according to a heat pump system for a vehicle according to an embodiment, in an extended range electric vehicle (EREV) applied with an engine for charging a battery, by controlling the flowing movement of the coolant flowing in respective cooling apparatuses by using a single valve depending on at least one mode for adjusting the temperature of the vehicle interior and for adjusting the temperature of the battery, streamlining of the entire system may be achieved.

According to an embodiment of the present disclosure, by adjusting the temperature of the vehicle interior and efficiently controlling the battery temperature by using the thermal energy generated from the engine, the usage of the electric heater at the time of heating the vehicle interior can be minimized, so that the power consumption amount may be reduced, and the overall marketability may be improved.

According to an embodiment of the present disclosure, the heating efficiency can be improved by using the thermal energy of the engine at the time of heating the vehicle interior, and the battery temperature can be efficiently adjusted to obtain the optimal performance of the battery, so that the overall travel distance of the vehicle may be increased.

According to an embodiment of the present disclosure, due to streamlining of the entire system, it can be possible to reduce the overall manufacturing cost and weight, and improve space utilization by minimizing the number of components.

### BRIEF DESCRIPTION OF THE DRAWINGS

FIG. 1 is a block diagram of a heat pump system for a vehicle according to an embodiment of the present disclosure.

FIG. 2 is an operation diagram according to a first mode in a heat pump system for a vehicle according to an embodiment of the present disclosure.

FIG. 3 is an operation diagram according to a second mode in a heat pump system for a vehicle according to an embodiment of the present disclosure.

FIG. 4 is an operation diagram according to a third mode in a heat pump system for a vehicle according to an embodiment of the present disclosure.

FIG. 5 is an operation diagram according to a fourth mode in a heat pump system for a vehicle according to an embodiment of the present disclosure.

FIG. 6 is an operation diagram according to a fifth mode in a heat pump system for a vehicle according to an embodiment of the present disclosure.

### DETAILED DESCRIPTION OF ILLUSTRATIVE EMBODIMENTS

Example embodiments of the present disclosure will hereinafter be described in detail with reference to the accompanying drawings.

Example embodiments disclosed in the present specification and the constructions depicted in the drawings are only examples, and do not necessarily cover the scopes of the present disclosure. Therefore, it can be understood that there may be various equivalents and variations for an embodiment of the present disclosure.

To clarify the present disclosure, parts that are not related to the description can be omitted, and same elements or equivalents can be referred to with same reference numerals throughout the specification.

The size and thickness of each element can be arbitrarily shown in the drawings, but the present disclosure is not necessarily limited thereto, and in the drawings, the thickness of layers, films, panels, regions, etc., can be exaggerated for clarity.

Unless explicitly described to the contrary, the word “comprise” and variations such as “comprises” or “comprising”, can be understood to imply the inclusion of stated elements but not the exclusion of any other elements.

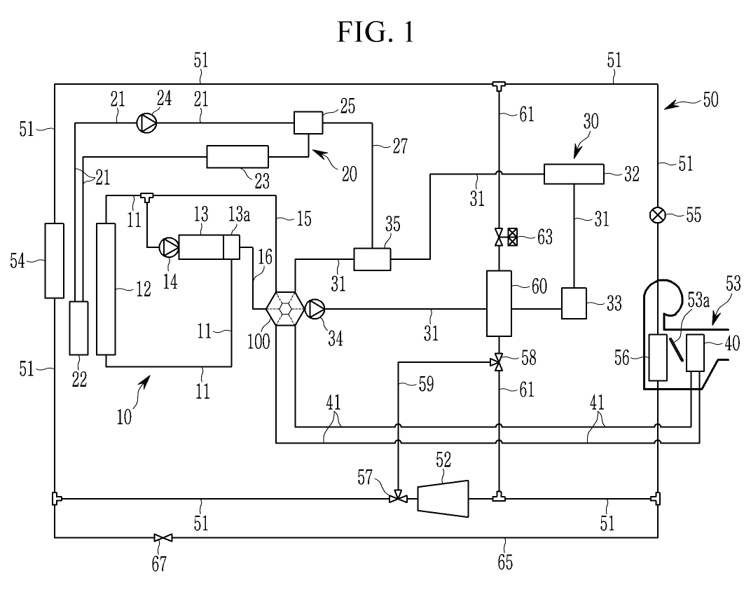

FIG. 1 is a block diagram of a heat pump system for a vehicle according to an embodiment of the present disclosure.

For a heat pump system for a vehicle according to an embodiment of the present disclosure, in an extended range electric vehicle (EREV) applied with an engine 13 for charging a battery 32, a flowing movement of a coolant flowing through respective cooling apparatuses can be controlled by using a single valve 100, depending on at least one mode for adjusting a temperature of a vehicle interior and for adjusting a temperature of the battery 32, the manufacturing cost and weight can be reduced while streamlining the entire system.

According to an embodiment of the present disclosure, by using the thermal energy generated from the engine 13, the temperature of the battery 32 may be efficiently controlled while adjusting the temperature of the vehicle interior.

Referring to FIG. 1, in a heat pump system according to an embodiment of the present disclosure, first, second, and third cooling apparatuses 10, 20, and 30, and a heater core 40, through which the coolant circulates, and an air conditioner unit 50 through which a refrigerant circulates may be interconnected with each other through a chiller 60.

That is, the heat pump system may include a first cooling apparatus 10, a second cooling apparatus 20, the third cooling apparatus 30, the heater core 40, the air conditioner unit 50, and a control valve 100, any of, any combination of, or all of which may be in plural or may include plural components thereof.

The first cooling apparatus 10 may include a first line 11 through which the coolant flows, and a first radiator 12, the engine 13, and a first water pump 14 provided on the first line 11.

The first radiator 12 may be disposed at the front of the vehicle. A cooling fan (not shown) may be provided on a downstream side of the first radiator 12. Accordingly, the first radiator 12 may cool the coolant through an operation of the cooling fan and heat-exchange with an ambient air.

The engine 13 may be selectively operated to charge the battery 32, and may be connected to the first radiator 12 through the first line 11.

The first water pump 14 may be provided on the first line 11 between the first radiator 12 and the engine 13. The first water pump 14 may be integrally configured in the engine 13.

The first cooling apparatus 10 configured as such may circulate the coolant along the first line 11 through an operation of the first water pump 14 so that the coolant cooled in the first radiator 12 is supplied to the engine 13.

In an embodiment of the present disclosure, the second cooling apparatus 20 may include a second line 21 through which the coolant flows, and a second radiator 22, an electrical component 23, and a second water pump 24 provided on the second line 21.

The second radiator 22 may be disposed in front of the first radiator 12. Accordingly, the second radiator 22 may cool the coolant through heat-exchange with the ambient air with the operation of the cooling fan.

The electrical component 23 may include an electrical power control unit (EPCU), or an inverter, or an on-board charger (OBC), or an autonomous driving controller, or the like, for example. The electrical component 23 may be provided on the second line 21 and cooled by a water-cooled manner.

The second water pump 24 may be provided on the second line 21 between the second radiator 22 and the electrical component 23.

The second cooling apparatus 20 may further include a reservoir tank 25 provided on the second line 21 between the electrical component 23 and the second water pump 24.

The second cooling apparatus 20 configured as such may circulate the coolant along the second line 21 through an operation of the second water pump 24 so that the coolant cooled in the second radiator 22 is supplied to the electrical component 23.

When cooling of the electrical component 23 is required in at least one mode for adjusting the temperature of the vehicle interior, or for adjusting the temperature of a battery, such a second cooling apparatus may be selectively operated so that the coolant flows along the second line 21.

In an embodiment of the present disclosure, the third cooling apparatus 30 may include a third line 31 through which the coolant flows, and the battery 32 and a third water pump 34 provided on the third line 31.

The battery 32 may supply power to a drive motor configured to provide a driving torque to the vehicle and the electrical component 23. The battery 32 may be charged by the engine 13 while driving the vehicle, or may be charged by being physically connected to an external power supply by using a charging cable.

The third cooling apparatus 30 may further include a coolant heater 33 provided on the third line at an upstream end of the battery 32.

The coolant heater 33 may be operated when a temperature of the coolant supplied to the battery 32 through the third line 31 is lower than a set, selected, or predetermined temperature.

That is, when the coolant heater 33 is operated, the coolant introduced into the third line 31 may be supplied to the battery 32 in a state of having an increased temperature by being heated while passing through the coolant heater 33.

When the temperature of the coolant flowing through the third line 31 is lower than the set, selected, or predetermined temperature, the coolant heater 33 may be selectively operated to increase the temperature of the coolant before the coolant is supplied to the battery 32.

The third cooling apparatus 30 configured as such may circulate the coolant along the third line 31 through an operation of the third water pump 34 so that the coolant is supplied to the battery 32.

That is, the electrical component 23 and the battery 32 may be cooled in a water-cooled manner.

The third cooling apparatus 30 may further include an air separator 35 provided on the third line 31 between the control valve 100 and a battery module 32.

The air separator 35 may separate bubbles included in the coolant flowing in the third cooling apparatus 30, and may discharge the separated bubbles to the reservoir tank 25 by using the head difference principle.

The air separator 35 may be connected to the reservoir tank 25 through a coolant connection line 27, so that the coolant flowing in the second cooling apparatus 20 and the third cooling apparatus 30 communicate with each other.

The coolant connection line 27 can be always filled with the coolant, and the bubbles separated from the coolant passing through the air separator 35 may be discharged to the reservoir tank 25 by using the head difference (i.e., pressure difference) principle.

Accordingly, the air separator 35 can divide the second line 21 and the third line 31 without using a separate electronic valve.

In an embodiment of the present disclosure, although it is described that both the second cooling apparatus 20 and the third cooling apparatus 30 are employed, the second cooling apparatus 20 and the third cooling apparatus 30 may be interconnected with the coolant connection line 27 through the air separator 35, to be configured as a single cooling apparatus.

In an embodiment of the present disclosure, the heater core 40 may be provided on a fourth line 41 through which the coolant flows. A first end and a second end of the fourth line 41 may be connected to the control valve 100 to selectively allow the coolant to flow.

Accordingly, when the vehicle interior is to be heated, a high-temperature coolant may be introduced into the heater core 40 through the fourth line 41 opened by the control valve 100.

The control valve 100 may be selectively connected to the first cooling apparatus 10 and the third cooling apparatus 30, and may control the flowing movement of the interiorly introduced coolant depending on at least one mode for adjusting the temperature of the vehicle interior or for adjusting the temperature of the battery.

The first cooling apparatus 10 may further include a first connection line 15 and a second connection line 16.

A first end of the first connection line 15 may be connected to the control valve 100. A second end of the first connection line 15 may be connected to the first line 11 between the first radiator 12 and the first water pump 14.

A first end of the second connection line 16 may be connected to the control valve 100. A second end of the second connection line 16 may be connected to an integrated flow control valve 13a provided in the engine 13.

The integrated flow control valve 13a may be connected to the first line 11 at an upstream end of the first radiator 12, based on a flow direction of the coolant flowing along the first line 11.

A first end and a second end of the third line 31 may be respectively connected to the control valve 100, and the coolant may selectively flow according to an operation of the control valve 100.

The first end and the second end of the fourth line 41 may be respectively connected to the control valve 100, and the coolant may selectively flow according to the operation of the control valve 100.

In an embodiment of the present disclosure, the air conditioner unit 50 may include a first refrigerant line 51 through which the refrigerant flows, a compressor 52 provided on the first refrigerant line 51, a heating, ventilation, and air-conditioning (HVAC) module 53, a first expansion valve 55, an evaporator 56, the chiller 60, a refrigerant connection line 61, and a second expansion valve 63.

The compressor 52 may compress the introduced refrigerant and allow the compressed refrigerant to flow along the first refrigerant line 51 so that the refrigerant circulates along the first refrigerant line 51.

In an embodiment of the present disclosure, the HVAC module 53 may be internally provided with the evaporator 56 and the heater core 40 connected through the first refrigerant line 51.

An opening/closing door 53a configured to adjust the ambient air having passed through the evaporator 56 to be selectively introduced into the heater core 40 may be internally provided in an interior of the HVAC module 53 between the evaporator 56 and the heater core 40.

When heating the vehicle interior, the opening/closing door 53a may be opened so that the ambient air having passed through the evaporator 56 can be introduced into the heater core 40.

The high-temperature coolant supplied to the heater core 40 may increase the temperature of the ambient air passing through the heater core 40. That is, the introduced ambient air may be converted into a high-temperature state while passing through the heater core 40 and then introduced into the vehicle interior, thereby implementing heating of the vehicle interior.

At the time of cooling the vehicle interior, the opening/closing door 53a may close a side toward the heater core 40 so that the ambient air cooled while passing through the evaporator 56 is directly introduced into the vehicle interior.

Accordingly, the ambient air passing through the evaporator 56 may be cooled while passing through the evaporator 56 by a low-temperature refrigerant supplied to the evaporator 56. The cooled ambient air may be introduced into the vehicle interior, thereby cooling the vehicle interior.

In an embodiment of the present disclosure, the heat-exchanger 54 may be connected to the compressor 52 through the first refrigerant line 51.

The heat-exchanger 54 may be disposed on the upstream side of the first radiator 12. Accordingly, the heat-exchanger 54 may selectively condense or evaporate the refrigerant introduced in the at least one mode through the operation of the cooling fan and heat-exchange with the ambient air.

In an embodiment of the present disclosure, the first expansion valve 55 may be provided on the first refrigerant line 51 connecting the heat-exchanger 54 and the evaporator 56. The first expansion valve 55 may selectively expand the introduced refrigerant.

The first expansion valve 55 may be a mechanical expansion valve configured to expand the refrigerant introduced through the first refrigerant line 51.

In an embodiment of the present disclosure, the first expansion valve 55 can be a mechanical expansion valve, for example, but is not limited thereto, and the first expansion valve 55 may be an electronic expansion valve configured to selectively expand the refrigerant while controlling a flowing movement of the supplied refrigerant.

The chiller 60 may be provided on the refrigerant connection line 61 so as to adjust the temperature of the coolant by heat-exchanging the selectively introduced coolant and the refrigerant. The chiller 60 may be connected to the third line 31.

Accordingly, the chiller 60 may heat-exchange the coolant flowing through the third line 31 with the refrigerant supplied through the refrigerant connection line 61. In the at least one mode, the chiller 60 may selectively condense or evaporate the introduced refrigerant.

The chiller 60 configured as such may be a water-cooled heat-exchanger into which the coolant is introduced through the third line 31.

A first end of the refrigerant connection line 61 may be connected to the first refrigerant line 51 between the heat-exchanger 54 and the first expansion valve 55. A second end of the refrigerant connection line 61 may be connected to the first refrigerant line 51 between the evaporator 56 and the compressor 52.

The second expansion valve 63 may be provided on the refrigerant connection line 61 between the first end of the refrigerant connection line 61 and the chiller 60.

The second expansion valve 63 may be an electronic expansion valve configured to selectively expand the refrigerant while controlling the flowing movement of the supplied refrigerant.

The air conditioner unit 50 configured as such may further include a first refrigerant valve 57, a second refrigerant valve 58, a second refrigerant line 59, a third refrigerant line 65, and a third refrigerant valve 67.

The first refrigerant valve 57 may be provided on the first refrigerant line 51 between the compressor 52 and the heat-exchanger 54.

The second refrigerant valve 58 may be provided on the refrigerant connection line 61 between the second end of the refrigerant connection line 61 and the chiller 60.

In an embodiment of the present disclosure, a first end of the second refrigerant line 59 may be connected to the first refrigerant valve 57. A second end of the second refrigerant line 59 may be connected to the second refrigerant valve 58.

The first refrigerant valve 57 and the second refrigerant valve 58 may be 3-way valves capable of controlling the flow rate of the refrigerant distribution and flowing movement.

A first end of the third refrigerant line 65 may be connected to the first refrigerant line between the compressor 52 and the heat-exchanger 54. A second end of the third refrigerant line 65 may be connected to the first refrigerant line 51 between the evaporator 56 and the compressor 52.

The third refrigerant valve 67 may be provided on the third refrigerant line 65.

In the heat pump system configured as such, the flowing movement of the coolant may be controlled by the control valve 100 depending on the at least one mode for adjusting the temperature of the vehicle interior or for adjusting the temperature of the battery 32.

The at least one mode may include a first mode, a second mode, a third mode, a fourth mode, and a fifth mode.

In the first mode, the battery 32 may be heated by using the thermal energy generated from the engine 13.

In the second mode, the vehicle interior may be heated by using the thermal energy generated from the engine 13.

In the third mode, the battery 32 may be cooled by using the coolant cooled in the first radiator 12.

In the fourth mode, the vehicle interior may be cooled by using the air conditioner unit 50, and the battery 32 may be cooled by using the coolant cooled while heat-exchanging with the refrigerant in the chiller 60.

In the fifth mode, the vehicle interior may be heated by using the coolant heated while heat-exchanging with the refrigerant in the chiller 60, and the battery 32 may be heated.

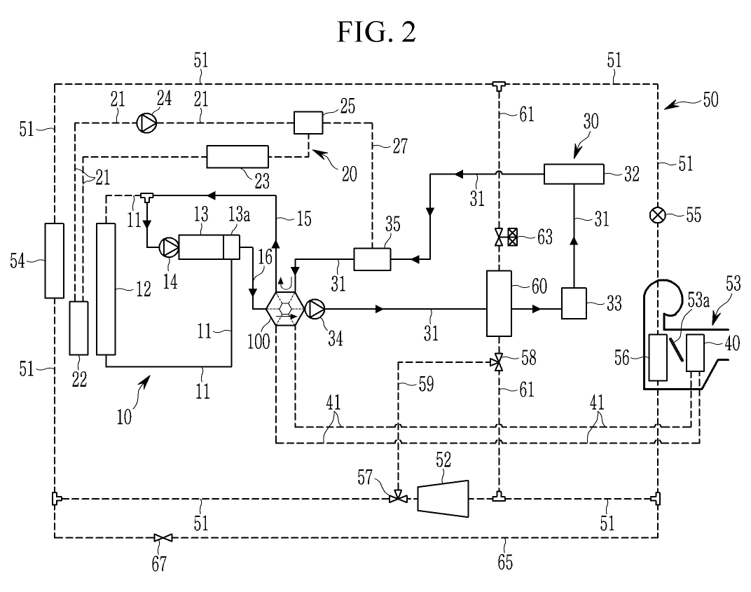

Hereinafter, an operation and action of a heat pump system for a vehicle according to an embodiment of the present disclosure configured as described above will be described in detail with reference to FIG. 2 to FIG. 6.

An operation in the first mode for heating the battery 32 by using the thermal energy generated from the engine 13 will be described in detail with reference to FIG. 2.

FIG. 2 is an operation diagram according to the first mode in a heat pump system for a vehicle according to an embodiment of the present disclosure.

Referring to FIG. 2, in the first mode, the heat pump system may heat the battery 32 by using the thermal energy generated from the engine 13.

A portion of the first line 11 connecting the integrated flow control valve 13a to the first radiator 12 and the second end of the first connection line 15 may be closed by the integrated flow control valve 13a.

A remaining first line 11 connecting the second end of the first connection line 15 to the first water pump 14 and the engine 13 may be opened by the integrated flow control valve 13a.

The first connection line 15 and the second connection line 16 may be opened by the control valve 100.

In an embodiment of the present disclosure, the third line 31 may be opened by the control valve 100 , and the fourth line 41 may be closed by the control valve 100.

Simultaneously, an operation of the air conditioner unit 50 may be stopped.

In such a state, the first water pump 14 and the third water pump 34 each may be operated.

Then, the coolant flowing along the first connection line 15 from the control valve 100 may be introduced into the engine 13 without passing through the first radiator 12.

Accordingly, the coolant supplied to the engine 13 may have an increased temperature by the thermal energy generated from the engine 13 while passing through the engine 13.

The high-temperature coolant heated while passing through the engine 13 may be introduced into the control valve 100 along the second connection line 16.

The high-temperature coolant introduced into the control valve 100 may flow along the third line 31 connected by the control valve 100, and supplied to the battery 32.

Then, the coolant having passed through the battery 32 may be introduced into the control valve 100 along the third line 31. The coolant introduced into the control valve 100 through the third line 31 may be discharged to the first connection line 15 connected by the control valve 100, thereby repeatedly performing the above-described processes.

The coolant heater 33 may be operated when the temperature of the coolant flowing through the third line 31 is lower than the set, selected, or predetermined temperature.

In the first mode, the battery 32 may be heated more rapidly and efficiently, by being supplied with the coolant heated by the thermal energy generated from the engine 13.

According to an embodiment of the present disclosure, by heating the battery 32 by using the coolant heated by the thermal energy generated from the engine 13, the power consumption for increasing the temperature of the battery 32 can be minimized.

FIG. 2 for explaining an operation in the first mode illustrates that the coolant does not flow through the second cooling apparatus 20, but it is not necessarily limited thereto.

In the first mode, when cooling of the electrical component 23 is required, the coolant cooled in the second radiator 22 may cool the electrical component 23 while flowing along the second line 21 by the operation of the second water pump 24.

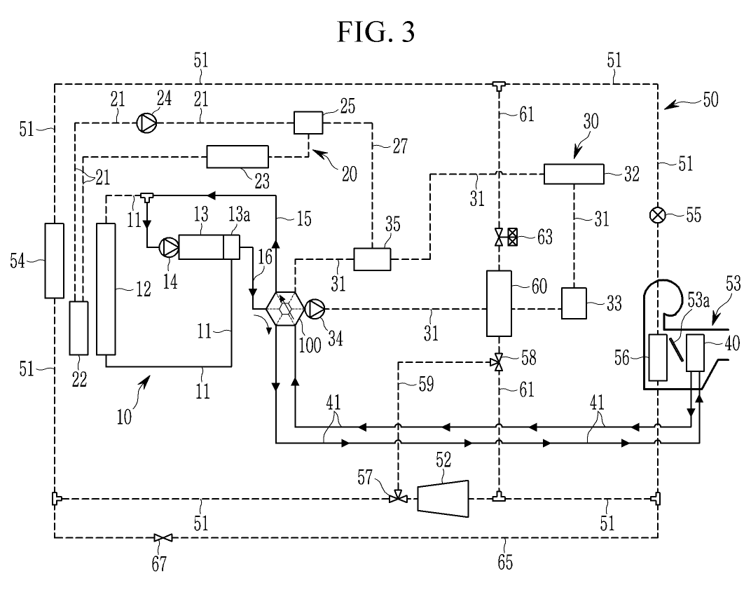

In an embodiment of the present disclosure, an operation in the second mode for heating the vehicle interior by using the thermal energy generated from the engine 13 will be described in detail with reference to FIG. 3.

FIG. 3 is an operation diagram according to the second mode in a heat pump system for a vehicle according to an embodiment of the present disclosure.

Referring to FIG. 3, in the second mode, the heat pump system may heat the vehicle interior by using the thermal energy generated from the engine 13.

A portion of the first line 11 connecting the integrated flow control valve 13a to the first radiator 12 and the second end of the first connection line 15 may be closed by the integrated flow control valve 13a.

A remaining first line 11 connecting the second end of the first connection line 15 to the first water pump 14 and the engine 13 may be opened by the integrated flow control valve 13a.

The first connection line 15 and the second connection line 16 may be opened by the control valve 100.

In an embodiment of the present disclosure, the third line 31 may be closed by the control valve 100. The fourth line 41 may be closed by the control valve 100.

Simultaneously, the operation of the air conditioner unit 50 may be stopped.

In such a state, the first water pump 14 may be operated.

Then, the coolant flowing along the first connection line 15 from the control valve 100 may be introduced into the engine 13 without passing through the first radiator 12.

Accordingly, the coolant supplied to the engine 13 may have an increased temperature by the thermal energy generated from the engine 13 while passing through the engine 13.

The high-temperature coolant heated while passing through the engine 13 may be introduced into the control valve 100 along the second connection line 16.

The high-temperature coolant introduced into the control valve 100 may flow along the fourth line 41 connected by the control valve 100, and supplied to the heater core 40.

The opening/closing door 53a may be opened so that the ambient air introduced into the HVAC module 53 and having passed through the evaporator 56 may pass through the heater core 40.

Accordingly, the ambient air introduced from the outside may be introduced at a room-temperature state without being cooled, when passing through the evaporator 56 that is not supplied with the refrigerant. The introduced ambient air may be converted into a high-temperature state while passing through the heater core 40 and then introduced into the vehicle interior, thereby implementing heating of the vehicle interior.

Then, the coolant having passed through the heater core 40 may be introduced into the control valve 100 along the fourth line 41. The coolant introduced into the control valve 100 through the fourth line 41 may be discharged to the first connection line 15 connected by the control valve 100, thereby repeatedly performing the above-described processes.

In the second mode, heating of the vehicle interior may be performed by using the thermal energy generated from the engine 13 without the operation of the air conditioner unit 50.

FIG. 3 for explaining an operation in the second mode illustrates that the coolant does not flow through the second cooling apparatus 20, but it is not limited thereto.

In the second mode, when cooling of the electrical component 23 is required, the coolant cooled in the second radiator 22 may cool the electrical component 23 while flowing along the second line 21 by the operation of the second water pump 24.

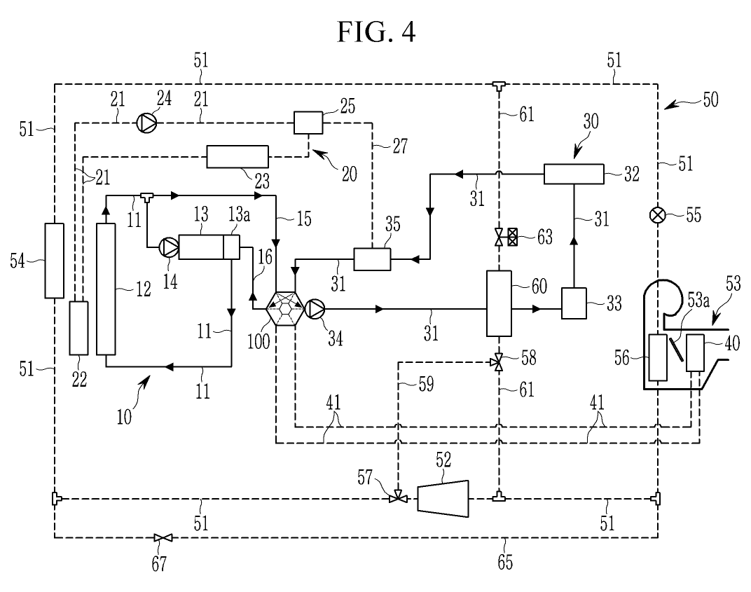

In an embodiment of the present disclosure, an operation in the third mode for cooling the battery 32 by using the coolant cooled in the first radiator 12 will be described in detail with reference to FIG. 4.

FIG. 4 is an operation diagram according to the third mode in a heat pump system for a vehicle according to an embodiment of the present disclosure.

Referring to FIG. 4, in the third mode, the heat pump system may cool the battery 32 by using the coolant cooled in the first radiator 12.

A portion of the first line 11 connecting the integrated flow control valve 13a to the first radiator 12 and the second end of the first connection line 15 may be opened by the integrated flow control valve 13a.

A remaining first line 11 connecting the second end of the first connection line 15 to the first water pump 14 and the engine 13 may be closed by the integrated flow control valve 13a.

The first connection line 15 and the second connection line 16 may be opened by the control valve 100.

In an embodiment of the present disclosure, the third line 31 may be opened by the control valve 100. The fourth line 41 may be closed by the control valve 100.

Simultaneously, the operation of the air conditioner unit 50 may be stopped.

In such a state, the third water pump 34 may be operated.

Then, the coolant flowing along the second connection line 16 from the control valve 100 may be introduced into the integrated flow control valve 13a.

The integrated flow control valve 13a may not allow the coolant introduced through the second connection line 16 to flow to the engine 13, but to flow to the first line 11 connected to the first radiator 12.

The coolant flowing through the first line 11 may be cooled while passing through the first radiator 12. A low-temperature coolant cooled in the first radiator 12 may be introduced into the control valve 100 along the opened portion of the first line 11 and the first connection line 15.

The low-temperature coolant introduced into the control valve 100 may flow along the third line 31 connected by the control valve 100, and supplied to the battery 32.

Then, the coolant having passed through the battery 32 may be introduced into the control valve 100 along the third line 31. The coolant introduced into the control valve 100 through the third line 31 may be discharged to the second connection line 16 connected by the control valve 100, thereby repeatedly performing the above-described processes.

In the third mode, the battery 32 may be cooled rapidly and efficiently, by being supplied with the coolant cooled in the first radiator 12.

FIG. 4 for explaining an operation in the third mode illustrates that the coolant does not flow through the second cooling apparatus 20, but it is not limited thereto.

In the third mode, when cooling of the electrical component 23 is required, the coolant cooled in the second radiator 22 may cool the electrical component 23 while flowing along the second line 21 by the operation of the second water pump 24.

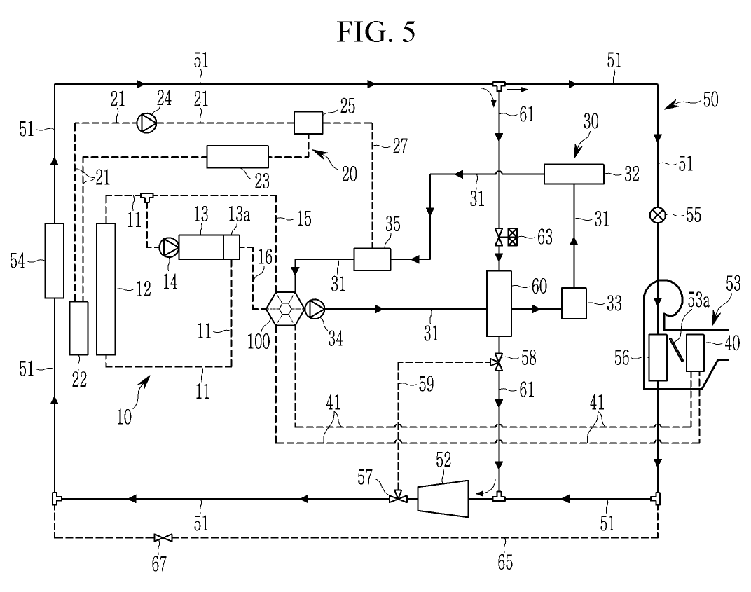

In an embodiment of the present disclosure, an operation in the fourth mode for cooling the vehicle interior by using the air conditioner unit 50, and for cooling the battery 32 by using the coolant cooled while heat-exchanging with the refrigerant in the chiller 60 will be described in detail with reference to FIG. 5.

FIG. 5 is an operation diagram according to the fourth mode in a heat pump system for a vehicle according to an embodiment of the present disclosure.

Referring to FIG. 5, in the fourth mode, the heat pump system may cool the vehicle interior by using the air conditioner unit 50, and the battery 32 may be cooled by using the coolant cooled while heat-exchanging with the refrigerant in the chiller 60.

The first connection line 15 and the second connection line 16 may be closed by the control valve 100.

Simultaneously, the third line 31 may be opened by the control valve 100. The fourth line 41 may be closed by the control valve 100.

In such a state, the third water pump 34 may be operated. Then, the coolant in the third cooling apparatus 30 may pass through the chiller 60, to be then supplied to the battery 32, while flowing from the control valve 100 along the third line 31.

In the air conditioner unit 50, the first refrigerant line 51 interconnecting the compressor 52, the heat-exchanger 54, the first expansion valve 55, and the evaporator 56 may be opened by the first expansion valve 55 and the first refrigerant valve 57.

The second refrigerant line 59 may be closed by the first refrigerant valve 57 and the second refrigerant valve 58.

Simultaneously, the refrigerant connection line 61 may be opened by the second expansion valve 63, to cool the battery 32. The third refrigerant line 65 may be closed by the third refrigerant valve 67.

In such a state, the refrigerant compressed in the compressor 52 may be introduced into the heat-exchanger 54 along the first refrigerant line 51. The heat-exchanger 54 may condense the refrigerant through heat-exchange with the ambient air.

The refrigerant condensed while passing through the heat-exchanger 54 may flow along the first refrigerant line 51.

A partial refrigerant among the refrigerant discharged from the heat-exchanger 54 may be supplied to the second expansion valve 63 while flowing along the refrigerant connection line 61.

The second expansion valve 63 may expand the refrigerant introduced through the refrigerant connection line 61and allow the expanded refrigerant to flow into the chiller 60 so that the battery 32 may be cooled by using the coolant heat-exchanged with the refrigerant in the chiller 60.

Accordingly, the coolant having passed through the chiller 60 while flowing along the third line 31 may be cooled through heat-exchange with the expanded refrigerant supplied to the chiller 60.

The coolant passing through the chiller 60 may be cooled through heat-exchange with the expanded refrigerant supplied to the chiller 60. The coolant cooled in the chiller 60 may be supplied to the battery 32 along the third line 31. Accordingly, the battery 32 may be efficiently cooled by the coolant cooled in the chiller 60.

A remaining refrigerant among the refrigerant discharged from the heat-exchanger 54 may be introduced into the first expansion valve 55 along the first refrigerant line 51 so as to cool the vehicle interior.

The first expansion valve 55 may expand the refrigerant introduced through the first refrigerant line 51 from the heat-exchanger 54 and supply the expanded refrigerant to the evaporator 56.

In such a state, the ambient air introduced into the HVAC module 53 may be cooled by the low-temperature refrigerant introduced into the evaporator 56 while passing through the evaporator 56.

The opening/closing door 53a may close a portion heading to the heater core 40 so that the cooled ambient air does not pass through the heater core 40. Therefore, the cooled ambient air may cool the vehicle interior by being directly introduced into the vehicle interior.

The refrigerant having passed through the evaporator 56 may be supplied to the compressor 52 along the first refrigerant line 51.

While repeatedly performing the above-described processes, in the fourth mode, the air conditioner unit 50 may cool the vehicle interior and at the same time, cool the coolant through heat-exchange while passing through the chiller 60.

The low-temperature coolant cooled in the chiller 60 may be supplied to the battery 32 through the third line 31. Accordingly, the battery 32 may be efficiently cooled by the supplied low-temperature coolant.

FIG. 5 for explaining an operation in the fourth mode illustrates that the coolant does not flow through the first cooling apparatus 10 and the second cooling apparatus 20, but it is not limited thereto.

In the fourth mode, when cooling of the electrical component 23 is required, the coolant cooled in the second radiator 22 may cool the electrical component 23 while flowing along the second line 21 by the operation of the second water pump 24.

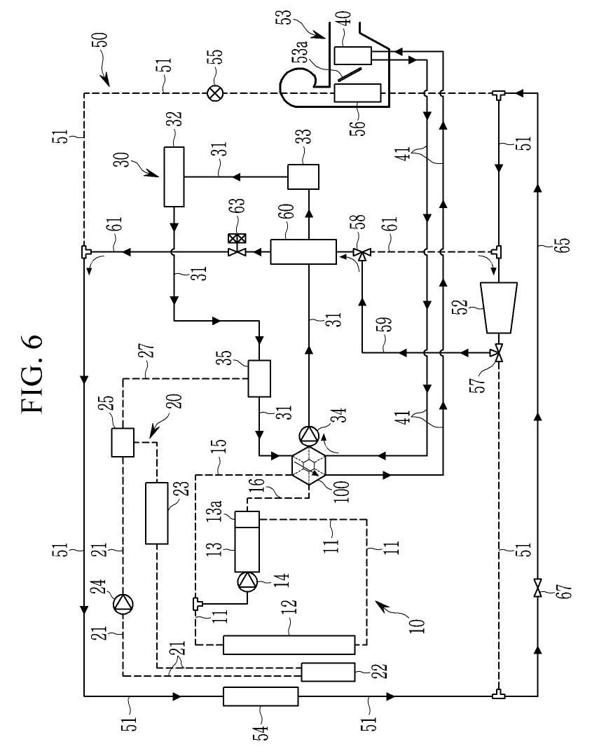

An operation in the fifth mode for heating the vehicle interior by using the coolant heated while heat-exchanging with the refrigerant in the chiller 60, and for heating the battery 32 will be described in detail with reference to FIG. 6.

FIG. 6 is an operation diagram according to the fifth mode in a heat pump system for a vehicle according to an embodiment of the present disclosure.

Referring to FIG. 6, in the fifth mode, the heat pump system may heat the vehicle interior by using the coolant heated while heat-exchanging with the refrigerant in the chiller 60, and may heat the battery 32.

The first connection line 15 and the second connection line 16 may be closed by the control valve 100.

Simultaneously, the third line 31 may be opened by the control valve 100. The fourth line 41 may be opened by the control valve 100.

In such a state, the third water pump 34 may be operated. Then, the coolant in the third cooling apparatus 30 may pass through the chiller 60, to be then supplied to the battery 32, while flowing from the control valve 100 along the third line 31.

The coolant having passed through the battery 32 may be introduced into the control valve 100 while flowing along the third line 31. The coolant introduced into the control valve 100 through the third line 31 may flow along the fourth line 41 connected by the control valve 100, and supplied to the heater core 40.

The coolant having passed through the heater core 40 may be introduced into the control valve 100 again while flowing along the fourth line 41.

Then, the coolant introduced into the control valve 100 through the fourth line 41 may be discharged again to the third line 31 by the control valve 100, thereby repeatedly performing the above-described processes.

In the air conditioner unit 50, a portion of the first refrigerant line 51 connecting the first refrigerant valve 57 to the first end of the third refrigerant line 65 may be closed by the first refrigerant valve 57.

A portion of the first refrigerant line 51 connecting the first end of the refrigerant connection line 61 to the second end of the third refrigerant line 65 by passing through the evaporator 56 may be closed by the first expansion valve 55.

An operation of the first expansion valve 55 may be stopped.

The second refrigerant line 59 may be opened by the first refrigerant valve 57 and the second refrigerant valve 58.

A portion of the refrigerant connection line 61 connecting the first end of the refrigerant connection line 61 to the second refrigerant valve 58 may be opened by the second expansion valve 63 and the second refrigerant valve 58.

The remaining refrigerant connection line 61 connecting the second end of the refrigerant connection line 61 to the second refrigerant valve 58 may be closed by the second refrigerant valve 58.

The third refrigerant line 65 may be opened by the third refrigerant valve 67.

In such a state, the refrigerant compressed in the compressor 52 may flow to the second refrigerant line 59 opened by the first refrigerant valve 57. The refrigerant flowing through the second refrigerant line 59 may be supplied to the chiller 60 along the portion of refrigerant connection line 61 opened by the second refrigerant valve 58.

The chiller 60 may condense the refrigerant while heat-exchanging the refrigerant supplied from the compressor 52 with the coolant introduced through the third line 31.

Simultaneously, the coolant introduced into the chiller 60 may have its temperature increased through heat-exchange with the refrigerant in the chiller 60.

The heated coolant may be first supplied to the battery 32 along the third line 31. Accordingly, the battery 32 may be heated rapidly and efficiently, by being supplied with the coolant heated while heat-exchanging with the refrigerant in the chiller 60.

The high-temperature coolant having passed through the battery 32 may be introduced into the control valve 100 along the third line 31. The coolant introduced into the control valve 100 through the third line 31 may flow to the fourth line 41 connected by the control valve 100, to be then introduced into the heater core 40.

The opening/closing door 53a may be opened so that the ambient air introduced into the HVAC module 53 and having passed through the evaporator 56 may pass through the heater core 40.

Accordingly, the ambient air introduced from the outside may be introduced at a room-temperature state without being cooled, when passing through the evaporator 56 that is not supplied with the refrigerant, and may pass through the heater core 40.

The ambient air passing through the heater core 40 may be converted into a high-temperature state through heat-exchange with the high-temperature coolant supplied to the heater core 40 and may be introduced into the vehicle interior, thereby achieving heating of the vehicle interior.

The coolant having passed through the heater core 40 may be introduced into the control valve 100 along the fourth line 41. The coolant introduced into the control valve 100 through the fourth line 41 may be discharged to the third line 31 connected by the control valve 100, thereby repeatedly performing the above-described processes.

The coolant heater 33 may be operated when the temperature of the coolant flowing through the third line 31 is lower than the set, selected, or predetermined temperature.

In an embodiment of the present disclosure, the refrigerant having passed through the chiller 60 may be introduced into the second expansion valve 63 along the opened portion of the refrigerant connection line 61.

The second expansion valve 63 may expand the refrigerant introduced through the refrigerant connection line 61 from the chiller 60.

The refrigerant expanded in the second expansion valve 63 may be supplied to the heat-exchanger 54 along the refrigerant connection line 61 and a portion the first refrigerant line 51. The heat-exchanger 54 may evaporate the refrigerant through heat-exchange with the ambient air.

The refrigerant to be evaporated in the heat-exchanger 54 may flow along the opened portion of the first refrigerant line 51 and the third refrigerant line 65, to be supplied to the compressor 52, and may repeatedly perform the above-described processes.

In the fifth mode, the coolant heated through heat-exchange in the chiller 60 is first supplied to the battery 32, thereby heating the battery 32 rapidly and efficiently.

According to an embodiment of the present disclosure, by heating the battery 32 by using the coolant heated increased through heat-exchange with the refrigerant supplied from the air conditioner unit 50, the power consumption for increasing the temperature of the battery 32 can be minimized.

Simultaneously, in the fifth mode, since the high-temperature coolant having passed through the battery 32 is supplied to the heater core 40 through the fourth line 41 connected by the control valve 100, heating of the vehicle interior may be performed by using the ambient air converted into a high-temperature state while passing through the heater core 40.

As described above, according to a heat pump system for a vehicle according to an embodiment of the present disclosure, in an extended range electric vehicle (EREV) applied with the engine 13 for charging of the battery 32, the flowing movement of the coolant flowing from the first cooling apparatus 10 or the third cooling apparatus 30 may be controlled by using the single control valve 100 depending on at least one mode for adjusting the temperature of the vehicle interior and for adjusting the temperature of the battery 32, thereby achieving streamlining of the entire system.

According to an embodiment of the present disclosure, by adjusting the temperature of the vehicle interior and efficiently control the temperature of the battery 32 by using the thermal energy generated from the engine 13, the usage of the electric heater at the time of heating of the vehicle interior can be minimized, so that the power consumption amount may be reduced, and the overall marketability may be improved.

According to an embodiment of the present disclosure, the heating efficiency may be improved by using the thermal energy of the engine 13 at the time of heating of the vehicle interior, and by efficiently adjusting the temperature of the battery 32 to achieve the optimal performance of the battery 32, the overall travel distance of the vehicle may be increased.

According to an embodiment of the present disclosure, due to streamlining of the entire system, it is possible to reduce the overall manufacturing cost and weight, and improve space utilization by minimizing the number of components.

While the present disclosure has been described in connection with what is presently considered to be practical example embodiments, it can be understood that the present disclosure is not necessarily limited to the disclosed example embodiments. On the contrary, the present disclosure can cover various modifications and equivalent arrangements included within the spirit and scopes of the appended claims.

What is claimed is:

1. A heat pump system, comprising:
a first apparatus comprising a first line configured to flow a coolant, wherein the first line is configured to flow the coolant through an engine, a first radiator, and a first water pump;
a second apparatus comprising a second line configured to flow the coolant, wherein the second line is configured to flow the coolant through an electrical component, a second radiator, and a second water pump on the second line;
a third apparatus comprising a third line configured to flow the coolant, wherein the third line is configured to flow the coolant through a battery and a third water pump;
a control valve selectively connected to the first apparatus and the third apparatus, wherein the control valve is configured to control a flowing movement of the coolant depending on at least one mode for adjusting a vehicle-interior temperature of a vehicle interior or for adjusting a battery temperature of the battery; and
a fourth line having a fourth-line first end and a fourth-line second end respectively connected the control valve to selectively allow the coolant to flow through the fourth line, wherein the fourth line is configured to flow the coolant through a heater core ,
wherein the first apparatus further comprises:
a first connection line having a first-connection-line first end connected to the control valve, and a first-connection-line second end connected to the first line at a first junction, wherein the first junction is on the first line where the first line is configured to be connected between the first radiator and the first water pump, and
a second connection line having a second-connection-line first end connected to the control valve, and a second-connection-line second end configured to be connected to an integrated flow control valve in the engine.

2. The system of claim 1, further comprising an air conditioner device, wherein the air conditioner device comprises:
a first refrigerant line configured to flow a refrigerant;
a compressor on the first refrigerant line, wherein the first refrigerant line is configured to flow the refrigerant through the compressor;
a heat-exchanger on the first refrigerant line, wherein the first refrigerant line is configured to flow the refrigerant through the heat-exchanger;
a first expansion valve on the first refrigerant line, wherein the first refrigerant line is configured to flow the refrigerant through the first expansion valve;
an evaporator on the first refrigerant line, wherein the first refrigerant line is configured to flow the refrigerant through the evaporator;
a first refrigerant valve on the first refrigerant line between the compressor and the heat-exchanger;
a second refrigerant line having a second-refrigerant-line first end connected to the first refrigerant valve;
a refrigerant connection line having a refrigerant-connection-line first end connected to the first refrigerant line between the heat-exchanger and the first expansion valve, and a refrigerant-connection-line second end connected to the first refrigerant line between the evaporator and the compressor;
a chiller on the refrigerant connection line configured to adjust a coolant temperature of the coolant by heat-exchanging the coolant and the refrigerant, wherein the chiller is connected to the third line;
a second expansion valve on the refrigerant connection line between the refrigerant-connection-line first end of the refrigerant connection line and the chiller; and
a second refrigerant valve on the refrigerant connection line between a refrigerant-connection-line second end of the refrigerant connection line and the chiller, and connected to a second-refrigerant-line second end of the second refrigerant line.

3. The system of claim 2, wherein the air conditioner device further comprises:
a third refrigerant line having a third-refrigerant-line first end connected to the first refrigerant line between the compressor and the heat-exchanger, and a third-refrigerant-line second end connected to the first refrigerant line between the evaporator and the compressor; and
a third refrigerant valve on the third refrigerant line.

4. The system of claim 3, wherein the at least one mode comprises:
a first mode for heating the battery by using thermal energy generated from the engine;
a second mode for heating the vehicle interior by using thermal energy generated from the engine;
a third mode for cooling the battery by using the coolant cooled in the first radiator;
a fourth mode for cooling the vehicle interior by using the air conditioner device, and for cooling the battery by using the coolant cooled by heat-exchanging with the refrigerant in the chiller; and
a fifth mode for heating the vehicle interior by using the coolant heated by heat-exchanging with the refrigerant at the chiller, and for heating the battery.

5. The system of claim 4, wherein, in the first mode, the system is configured such that:
a first portion of the first line connecting the integrated flow control valve to the first radiator and a first-connection-line second end of the first connection line is closed by the integrated flow control valve;
a remaining second portion of the first line connecting the first-connection-line second end of the first connection line to the first water pump and the engine is opened by the integrated flow control valve;
the first connection line and the second connection line are opened by the control valve;
the third line is opened by the control valve;
the fourth line is closed by the control valve;
the first water pump and the third water pump are operated; and
an operation of the air conditioner device is stopped.

6. The system of claim 4, wherein, in the second mode, the system is configured such that:
a first portion of the first line connecting the integrated flow control valve to the first radiator and a first-connection-line second end of the first connection line is closed by the integrated flow control valve;
a remaining second portion of the first line connecting the first-connection-line second end of the first connection line to the first water pump and the engine is opened by the integrated flow control valve;
the first connection line and the second connection line are opened by the control valve;
the third line is closed by the control valve;
the fourth line is opened by the control valve;
the first water pump is operated; and
an operation of the air conditioner device is stopped.

7. The system of claim 4, wherein, in the third mode, the system is configured such that:
a first portion of the first line connecting the integrated flow control valve to the first radiator and a first-connection-line second end of the first connection line is opened by the integrated flow control valve;
a remaining second portion of the first line connecting the first-connection-line second end of the first connection line to the first water pump and the engine is closed by the integrated flow control valve;
the first connection line and the second connection line are opened by the control valve;
the third line is opened by the control valve;
the fourth line is closed by the control valve;
the third water pump is operated; and
an operation of the air conditioner device is stopped.

8. The system of claim 4, wherein, in the fourth mode, the system is configured such that:
the first connection line and the second connection line are closed by the control valve;
the third line is opened by the control valve;
the fourth line is closed by the control valve;
the third water pump is operated;
the first refrigerant line is opened by the first expansion valve and the first refrigerant valve;
the second refrigerant line is closed by the first refrigerant valve and the second refrigerant valve;
the third refrigerant line is closed by the third refrigerant valve;
the refrigerant connection line is opened by the second expansion valve;
the first expansion valve expands the refrigerant introduced through the first refrigerant line from the heat-exchanger and supplies a first expanded refrigerant to the evaporator;
the second expansion valve expands the refrigerant introduced through the refrigerant connection line and supplies a second expanded refrigerant to the chiller; and
the refrigerant having passed through the chiller is introduced into the compressor together with the refrigerant discharged from the evaporator.

9. The system of claim 4, wherein, in the fifth mode, the system is configured such that:
the first connection line and the second connection line are closed by the control valve;
the third line is opened by the control valve;
the fourth line is opened by the control valve;
the third water pump is operated;
a first first-refrigerant-line portion of the first refrigerant line connecting the first refrigerant valve to a third-refrigerant-line first end of the third refrigerant line is closed by the first refrigerant valve;
a second first-refrigerant-line portion of the first refrigerant line connecting a refrigerant-connection-line first end of the refrigerant connection line to a third-refrigerant-line second end of the third refrigerant line by passing through the evaporator is closed by the first expansion valve;
the second refrigerant line is opened by the first refrigerant valve and the second refrigerant valve;
a first refrigerant-connection-line portion of the refrigerant connection line connecting the refrigerant-connection-line first end of the refrigerant connection line to the second refrigerant valve is opened by the second expansion valve and the second refrigerant valve;
a remaining second refrigerant-connection-line portion of the refrigerant connection line connecting the refrigerant-connection-line second end of the refrigerant connection line to the second refrigerant valve is closed by the second refrigerant valve;
the third refrigerant line is opened by the third refrigerant valve;
the first expansion valve stops operating; and
the second expansion valve expands the refrigerant introduced through the refrigerant connection line from the chiller and supplies a first expanded refrigerant to the heat-exchanger.

10. The system of claim 2, wherein the heat-exchanger and the chiller are configured to selectively condense or evaporate the refrigerant introduced in the at least one mode.

11. The system of claim 2, wherein the second expansion valve includes an electronic expansion valve configured to selectively expand the refrigerant while controlling a flowing movement of the refrigerant.

12. The system of claim 2, wherein the first refrigerant valve and the second refrigerant valve include 3-way valves capable of controlling a flow rate of the refrigerant for distribution and flowing movement.

13. The system of claim 1, wherein, based on cooling of the electrical component being selected in the at least one mode, the system is configured such that the second apparatus is selectively operated so that the coolant flows along the second line.

14. The system of claim 2, wherein the air conditioner device further comprises:
an air-conditioner-heating-control device including therein the heater core and the evaporator, and
a door in the air-conditioner-heating-control device, wherein the door is configured to adjust air flow having passed through the evaporator to be selectively introduced into the heater core depending on a cooling or heating selection of the vehicle interior.

15. The system of claim 1, wherein the third apparatus further comprises an air separator on the third line between the control valve and a battery module.

16. The system of claim 15, wherein the second apparatus further comprises a reservoir tank on the second line.

17. The system of claim 16, wherein the air separator is configured to separate bubbles generated from the coolant flowing in the third apparatus and discharge the separated bubbles to the reservoir tank, and wherein the air separator is connected to the reservoir tank through a coolant connection line so that the coolant of the second apparatus and the third apparatus can communicate with each other via the coolant connection line.

18. The system of claim 1, wherein the third apparatus further comprises a coolant heater on the third line at an upstream end of the battery.

19. A control valve for a heat pump system, comprising:
a first-connection-line connector configured to be connected to and flow a coolant through a first connection line, wherein the first connection line is configured to connect between the control valve and a first junction on a first line, wherein the first line is configured to flow a coolant through a first water pump, an engine, and a first radiator, and wherein the first junction is on the first line where the first line is configured to be connected between the first radiator and the first water pump;
a second-connection-line connector configured to be connected to and flow the coolant from a second connection line to the control valve, wherein the second connection line is configured to connect between the control valve and an integrated flow control valve in the engine;
a first third-line connector configured to be connected to and flow the coolant from a third line to the control valve, wherein the third line is configured to be selectively connected to a second line, wherein the second line is configured to flow the coolant through a second water pump, an electrical component, and a second radiator, and wherein the third line is configured to flow the coolant through a third water pump and a battery;
a second third-line connector configured to be connected to and flow the coolant from the control valve to the third line;
a first fourth-line connector configured to be connected to and flow the coolant from the control valve through a heater core via a fourth line; and
a second fourth-line connector configured to be connected to and flow the coolant from the fourth line to the control valve,
wherein the control valve is configured to selectively control a flowing movement of the coolant among at least one of the a first-connection-line connector, the second-connection-line connector, the first third-line connector, the second third-line connector, the first fourth-line connector, or the second fourth-line connector, depending on at least one mode for adjusting a vehicle-interior temperature of a vehicle interior or for adjusting a battery temperature of the battery.

20. A vehicle comprising:
a battery configured to power motion of the vehicle;
an engine configured to charge the battery;
an electrical component; and
a heat pump system, comprising:
a first apparatus comprising:
a first line configured to flow a coolant, wherein the first line is configured to flow the coolant through the engine,
a first radiator on the first line, wherein the first line is configured to flow the coolant through the first radiator, and
a first water pump on the first line, wherein the first line is configured to flow the coolant through the first water pump,
a second apparatus comprising:
a second line configured to flow the coolant, wherein the second line is configured to flow the coolant through the electrical component,
a second radiator on the second line, wherein the second line is configured to flow the coolant through the second radiator, and
a second water pump on the second line, wherein the second line is configured to flow the coolant through the second water pump,
a third cooling apparatus comprising:
a third line configured to flow the coolant, wherein the third line is configured to flow the coolant through the battery, and
a third water pump on the third line, wherein the third line is configured to flow the coolant through the third water pump,
a control valve selectively connected to the first apparatus and the third cooling apparatus, wherein the control valve is configured to control a flowing movement of the coolant depending on at least one mode for adjusting a vehicle-interior temperature of a vehicle interior or for adjusting a battery temperature of the battery,
a fourth line having a fourth-line first end and a fourth-line second end respectively connected the control valve to selectively allow the coolant to flow through the fourth line, and
a heater core on the fourth line, wherein the fourth line is configured to flow the coolant through the heater core,
wherein the first apparatus further comprises:
a first connection line having a first-connection-line first end connected to the control valve, and a first-connection-line second end connected to the first line between the first radiator and the first water pump, and
a second connection line having a second-connection-line first end connected to the control valve, and a second-connection-line second end configured to be connected to an integrated flow control valve in the engine.
